(19) United States
(12) Patent Application Publication
(10) Pub. No.: US 2014/0291348 A1
(43) Pub. Date: Oct. 2, 2014

(54) DISPENSING DEVICE FOR VENDING MACHINE

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: CHAO LIU, Wuhan (CN); ZHI-PING WU, Wuhan (CN); TING-TING HE, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/105,178

(22) Filed: Dec. 13, 2013

(30) Foreign Application Priority Data
Mar. 28, 2013 (CN) 2013101041413

(51) Int. Cl. G07F 11/00

(52) U.S. Cl. CPC G07F 11/005
USPC 221/251

(57) ABSTRACT

A dispensing device for a vending machine includes a first sidewall, a second sidewall, and output plate. A product channel and an outlet are defined between the first sidewall and the second sidewall. The outlet is located on bottom of the product channel. The output plate is located on the outlet. The output plate is movable from the outlet. A first damping board extends to the product channel and is located on top of the outlet to dampen at least one vertically moving product.

### BACKGROUND

1. Technical Field

The disclosure generally relates to dispensing devices, especially for a dispensing device for the vending machine.

2. Description of Related Art

A vending machine includes a dispensing device for dispensing product to customers. A traditional dispensing device is gravity fed. Product are supported by an output baffle and stacked in a product channel of the traditional dispensing device along a vertical direction. When a customer requires one product, the output baffle is removed from the product channel until the bottom product drops out of the product channel. The remaining product in the product channel move vertically and impact the output baffle strongly. Noise may be generated and the output baffle may be damaged after long time use. There is a room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a dispending device of a vending machine of one embodiment.

FIG. 2 is a lateral, assembled view of the dispending device of FIG. 1.

FIG. 3 is similar to FIG. 2, but a plurality of product is located in the product channel and the outlet.

FIG. 4 is similar to FIG. 3, but an output plate is opened.

FIG. 5 is similar to FIG. 3, but with a bottom product dropped out of the outlet.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

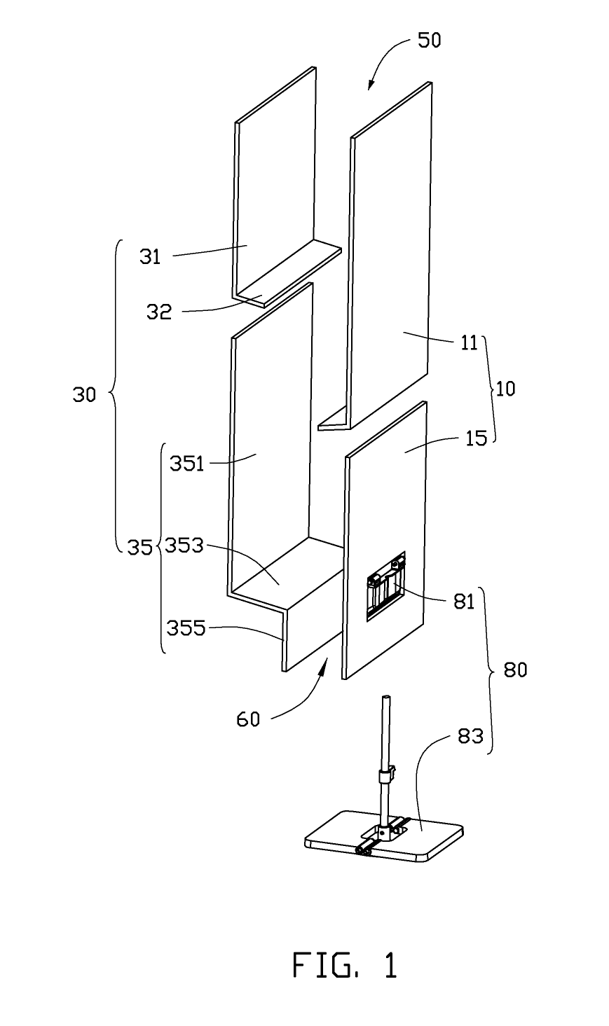

FIG. 1 illustrates one embodiment of a dispensing device for a vending machine. The dispending device includes a first sidewall 10, a second sidewall 30, and an output control assembly 80. A product channel 50 and an outlet 60 are defined between the first sidewall 10 and a second sidewall 30. The outlet 60 is located on bottom of the product channel 50. The output control assembly 80 includes a control board 81 and an output plate 83.

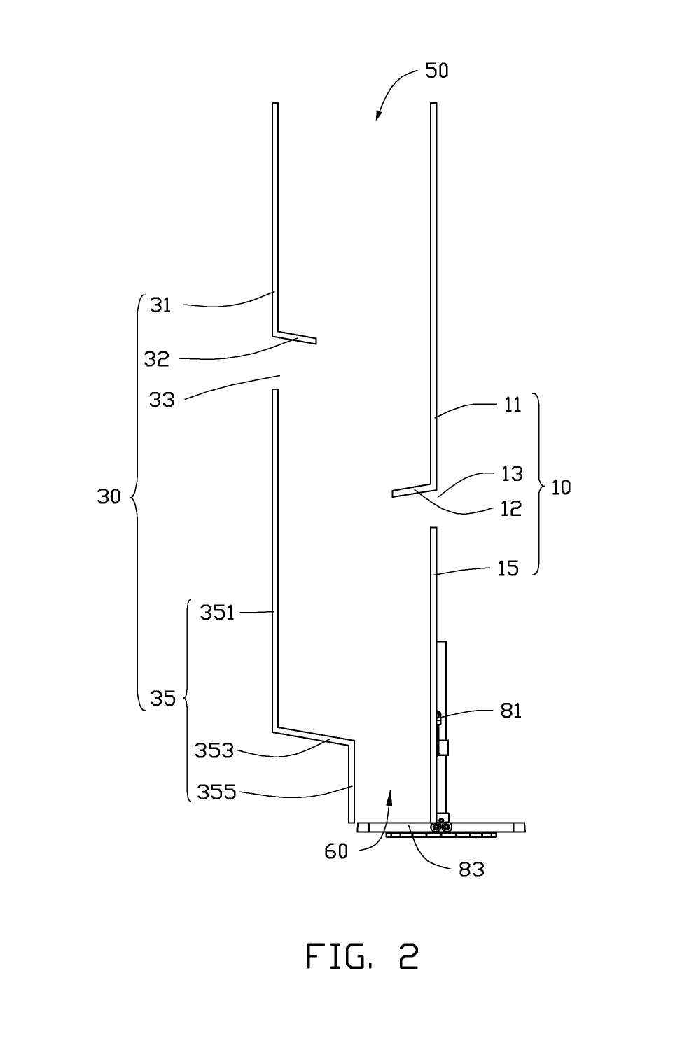

FIG. 2 illustrates a lateral, assembled view of the dispensing device of FIG. 1. The first sidewall 10 includes a first top sidewall 11, and a first bottom sidewall 15. A first damping board 12 extends from the first sidewall 10 into the product channel 50. The first damping board 12 extends slightly down relative to a horizontal direction. A first opening 13 is defined in the first sidewall 10 under the first damping board 12. The first damping board 12 is integral with the first sidewall 10. The control board 81 is attached to the first bottom sidewall 15.

The second sidewall 30 includes a second top sidewall 31 and a second bottom sidewall 35. A second damping board 32 extends from the second sidewall 30 into the product channel 50. The second damping board 32 extends slightly down relative to the horizontal direction. A second opening 33 is defined in the second sidewall 30 under the second damping board 32. The second damping board 32 is integral with the second sidewall 30. The second damping board 32 is staggered to the first damping board 12 along the horizontal direction. The second damping board 32 is located on top of the first damping board 12 along a vertical direction. The second damping board 32 has the same configuration relative to the first damping board 12. The second bottom sidewall 35 includes a product channel sidewall 351, a supporting board 353, and an output sidewall 355. The product channel sidewall 351 and the output sidewall 355 are both substantially parallel to the first sidewall 10. The supporting board 353 extends substantially along the horizontal direction and is oblique down to the outlet 60.

The product channel 50 is defined between a top portion of the first sidewall 10, and the second top sidewall 31 and the product channel sidewall 351. The outlet 60 is defined between a bottom portion of the first sidewall 10 and the output sidewall 355. A width of the product channel 50 is about twice a width of the outlet 60. An extending direction of the first damping board 12 along the horizontal direction is substantially smaller than the width of the outlet 60. The extending direction of the first damping board 12 along the horizontal direction is about half of the width of the outlet 60. A distance between the first damping board 12 and the outlet 60 is not greater than about three times of the width of the outlet 60.

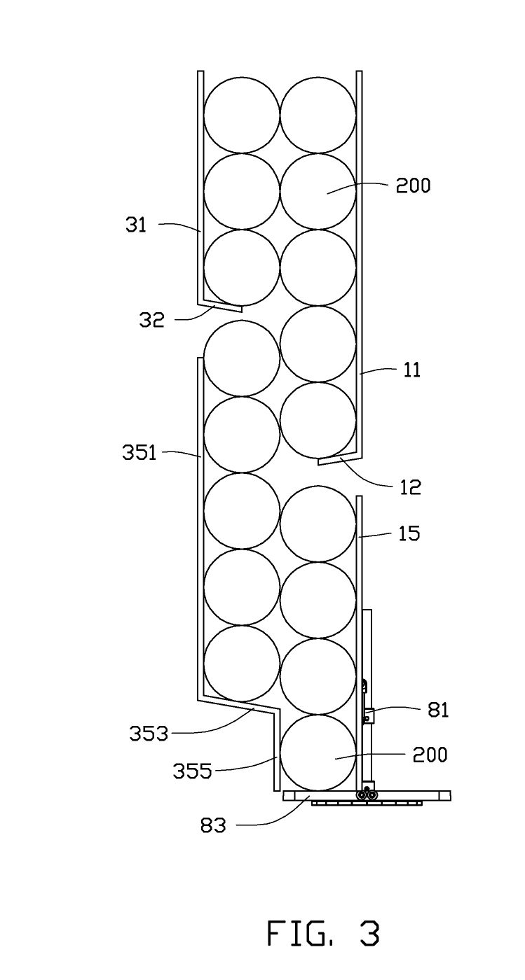

FIG. 3 is an assembled view of the dispensing device of FIG. 2. A plurality of product 200 is stacked in the channel 50 in two lines and a bottom product is located in the outlet 60 in one line. The outlet plate 83 supports the stacked product 200.

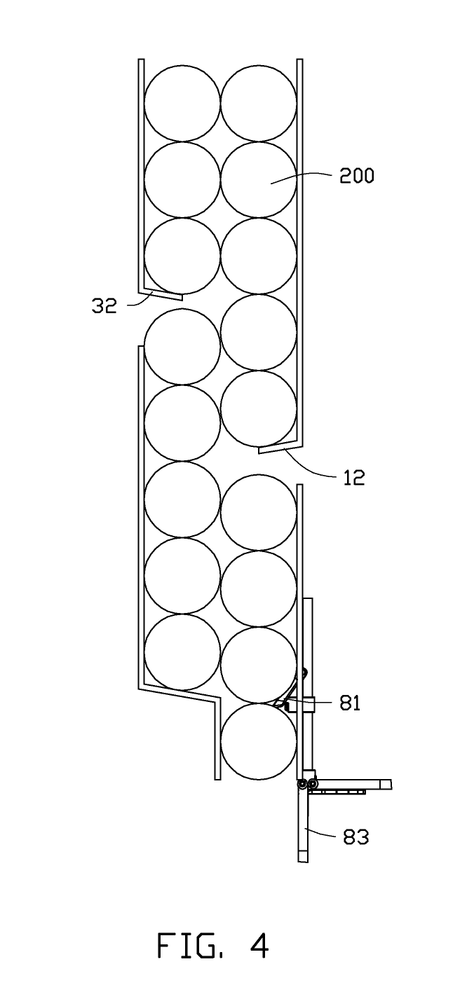

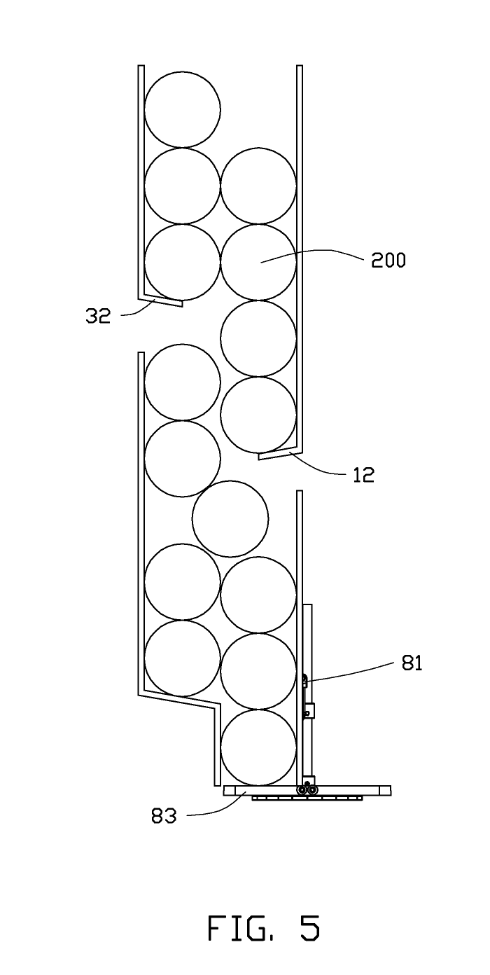

FIG. 4 and FIG. 5 illustrate two states of the dispensing device when one product 200 drops out of the outlet 60. When a customer requires one product, the outlet plate 83 is removed from the outlet 60 until the bottom product drops out of the outlet 60.

When the outlet plate 83 moves back to the outlet 60, the product 200 left stacked in the product channel 50 moves down. The first damping board 12 and the second damping board 32 dampen the product 200 and stop and bias the product 200 from the vertical direction.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A dispensing device for a vending machine, comprising:
a first sidewall;
a second sidewall;
a product channel and an outlet defined between the first sidewall and the second sidewall, and the outlet located on bottom of the product channel; and
an output plate located on the outlet, and the output plate being movable from the outlet;
wherein a first damping board extends to the product channel and is located on top of the outlet to dampen at least one vertically moving goods.

2. The dispensing device of claim 1, wherein the first damping board extends down relative to the first sidewall.

3. The dispensing device of claim 2, wherein the first damping board is integral with the first sidewall, and a first opening is defined in the first sidewall at a bottom of the first damping board.

4. The dispensing device of claim 1, wherein a second damping board extends to the product channel, and the second damping board is staggered to the first damping board along a horizontal direction.

5. The dispensing device of claim 4, wherein the second damping board is located on top of the first damping board along a vertical direction.

6. The dispensing device of claim 5, wherein the second damping board has the same configuration relative to the first damping board.

7. The dispensing device of claim 1, wherein a width of the product channel is about twice of a width of the outlet.

8. The dispensing device of claim 1, wherein an extending direction of the first damping board along a horizontal direction is substantially smaller than a width of the outlet.

9. The dispensing device of claim 8, wherein the extending direction of the first damping board along the horizontal direction is about half of the width of the outlet.

10. The dispensing device of claim 1, wherein a distance between the first damping board and the outlet is not greater than about three times of a width of the outlet.

11. A dispensing device for a vending machine, comprising:
a first sidewall;
a second sidewall;
a product channel and an outlet defined between the first sidewall and the second sidewall, and the outlet located on bottom of the product channel; and
an output plate located on the outlet, and the output plate being movable from the outlet;
wherein a first damping board and a second damping board extend to the product channel to bias at least one product from a vertical direction.

12. The dispensing device of claim 11, wherein the first damping board extends down relative to the first sidewall.

13. The dispensing device of claim 12, wherein the first damping board is integral with the first sidewall, and a first opening is defined in the first sidewall at a bottom of the first damping board.

14. The dispensing device of claim 11, wherein the second damping board is staggered to the first damping board along a horizontal direction.

15. The dispensing device of claim 14, wherein the second damping board is located on top of the first damping board along the vertical direction.

16. The dispensing device of claim 15, wherein the second damping board has the same configuration relative to the first damping board.

17. The dispensing device of claim 11, wherein a width of the product channel is about twice of a width of the outlet.

18. The dispensing device of claim 11, wherein an extending direction of the first damping board along a horizontal direction is substantially smaller than a width of the outlet.

19. The dispensing device of claim 18, wherein the extending direction of the first damping board along the horizontal direction is about half of the width of the outlet.

20. The dispensing device of claim 11, wherein a distance between the first damping board and the outlet is not greater than about three times of a width of the outlet.
